(19) United States
(12) Patent Application Publication
(10) Pub. No.: US 2011/0279671 A1
(43) Pub. Date: Nov. 17, 2011

(54) DEVICE FOR MONITORING A FACILITY PROVIDED WITH CAMERA

(75) Inventors: Vincent Weber, Paris (FR); Jean-Michel Gliner, Corenc (FR); Jean-Noel Avila, Chambery (FR)

(73) Assignee: VISIDOM, Corenc (FR)

(21) Appl. No.: 12/988,656

(22) PCT Filed: Apr. 23, 2009
(86) PCT No.: PCT/FR09/50756

§ 371 Date: Feb. 8, 2011

(30) Foreign Application Priority Data
Apr. 24, 2008 (FR) 0852767

(51) Int. Cl. H04N 7/18

(52) U.S. Cl. 348/143; 348/E07.085

(57) ABSTRACT

A device for monitoring an installation comprising means for issuing a cue to the environment of a camera indicating that the camera is passing from a state in which it is not capable of picking up images to a state in which it is capable of picking up images, or is indeed picking them up, and vice versa. The cue is issued in at least one of the following two forms: a movement of a mask suitable for covering a lens of the camera; and a sound signal.

### CROSS-REFERENCE TO RELATED APPLICATIONS

This application is the U.S. National Phase application of PCT/FR2009/050756 filed Apr. 23, 2009, which claims priority to French Application No. 0852767 filed Apr. 24, 2008, which applications are incorporated herein by reference and made a part hereof.

### BACKGROUND OF THE INVENTION

1. Field of the Invention

The invention relates to monitoring an installation such as a home or professional premises.

2. Description of the Related Art

It is known to provide an installation with a monitoring device such as an alarm station suitable for detecting the occurrence of an abnormal situation and for informing a remote monitoring center that is situated at a distance therefrom. The abnormal situation may for example be an intruder penetrating into the installation. For this purpose, the device includes at least one camera having a field of view that covers at least a significant fraction of the area of the installation. If the installation is a home, the camera covers at least one room or a location in the home where people pass.

Unfortunately, such a camera is itself often perceived to be an intrusion by the occupants of the installation. It may even give rise to a psychological effect of repugnance with such people. Since the camera is arranged to communicate with the remote monitoring center, the occupants have the feeling that they are being filmed continuously. Nevertheless, the camera is usually inactive when occupants are present, since one of them will have deactivated the device on returning to the premises. In numerous circumstances, it is only when the occupants are absent that the camera is active. Nevertheless, the uncomfortable feeling persists. It is particularly strong in a home where the occupants have the permanent feeling that their private life or their privacy is being filmed. It is found that this suspicion does not go away when the system is switched off or deactivated. It is the mere presence of the camera that gives rise to this distrust.

What is needed, therefore, is a system and method for overcoming one or more of the problems noted above.

### SUMMARY OF THE INVENTION

An object of one embodiment of the invention is to improve this aspect of integrating monitoring systems in installations, regardless of whether they are homes or professional premises, by making it easier for the occupants to accept such systems.

To this end, the invention provides a device for monitoring an installation, wherein the device comprises means suitable for issuing a cue to an environment of a camera indicating that the camera is passing from a state in which it is not capable of picking up images to a state in which it is capable of picking up images, or is indeed picking them up, and vice versa, such that the cue is issued in at least one of the following two forms:

a movement of a mask suitable for covering a lens of the camera; and

a sound signal.

Thus, the occupants of the installation are informed about a change of state of the camera and therefore know immediately when it switches to a state in which it is capable of filming. Similarly, they are immediately informed when that state comes to an end. By means of this information given to occupants, suspicion of the camera may go away.

The warning in the form of a sound enables the occupants to be informed about the change of state even if they are not looking at the camera when the change takes place. Depending on the volume selected for the sound signal, they may even be warned when they are in a room next to the room in which the camera is located.

The movement of the mask is perceived as being particularly reassuring. When the mask is closed, the occupant has concrete proof and thus certainty that no image of the occupant can be picked up by the camera. This constitutes a form of warning that is particularly credible for the occupant and thus very convincing. In addition, the information in this respect remains available after the change of state. Depending on the open or closed position occupied by the mask, the occupant can determine at all times whether the camera is capable of picking up images of the occupant. Occupants can thus determine at any time whether the camera is active or inactive, merely by looking at it.

The invention thus improves the integration of the alarm system within installations, be they homes or professional premises.

Preferably, the control means are suitable for issuing the cue both in the form of the movement of the shut-off means and in the form of the sound signal.

Thus, the device gives occupants a better chance of being informed about a change of state of the camera. Regardless of whether or not the occupants are in the direct proximity of the camera, and regardless of whether or not they are looking at it, they can be informed at all times about the active or inactive state of the camera.

Advantageously, the control means are suitable for issuing the cue in the form of sound signals that differ depending on whether the camera is passing from the state in which it is not in a position to pick up images to the state in which it is in a position to pick up images, or vice versa.

The occupant can thus easily identify and distinguish between a change to the active state and a change to the inactive state. In addition, if the occupant had not observed the change of the active state, the sound signal indicating a change to the inactive state will nevertheless be recognized and not confused with a change to the active state.

Preferably, the camera includes the control means.

Advantageously, in one embodiment, the camera includes means for issuing the sound signal.

Advantageously, in another embodiment, the device has a plurality of cameras and the control means are suitable for issuing the cue by means of sound signals that are different for the respective cameras.

Thus, depending on the sound signal emitted, the occupant can identify which camera has changed state, by recognizing the sound signal that is associated therewith.

The invention also provides a method for monitoring an installation, wherein a cue is issued to the environment of a camera indicating that the camera is passing from a state in which it is not capable of picking up images to a state in which it is capable of picking up images, or is indeed picking them up, and vice versa, such that the cue is issued in at least one of the following two forms:

a movement of a mask suitable for covering a lens of the camera; and

a sound signal.

The invention also provides a program including instructions for implementing the method, a data recording medium including such a program recorded thereon, and, finally, making such a program available for downloading on a telecommunications network.

### BRIEF DESCRIPTION OF THE ACCOMPANYING DRAWINGS

Other characteristics and advantages of the invention appear further from the following description of a preferred embodiment given by way of non-limiting example with reference to the accompanying drawings, in which:

FIG. 1 is a diagrammatic view of a remote monitoring system including a device of the invention;

FIG. 2 is a perspective view of one of the cameras forming part of the FIG. 1 system; and

FIG. 3 is a diagrammatic view of the FIG. 2 camera.

### DETAILED DESCRIPTION OF THE PREFERRED EMBODIMENTS

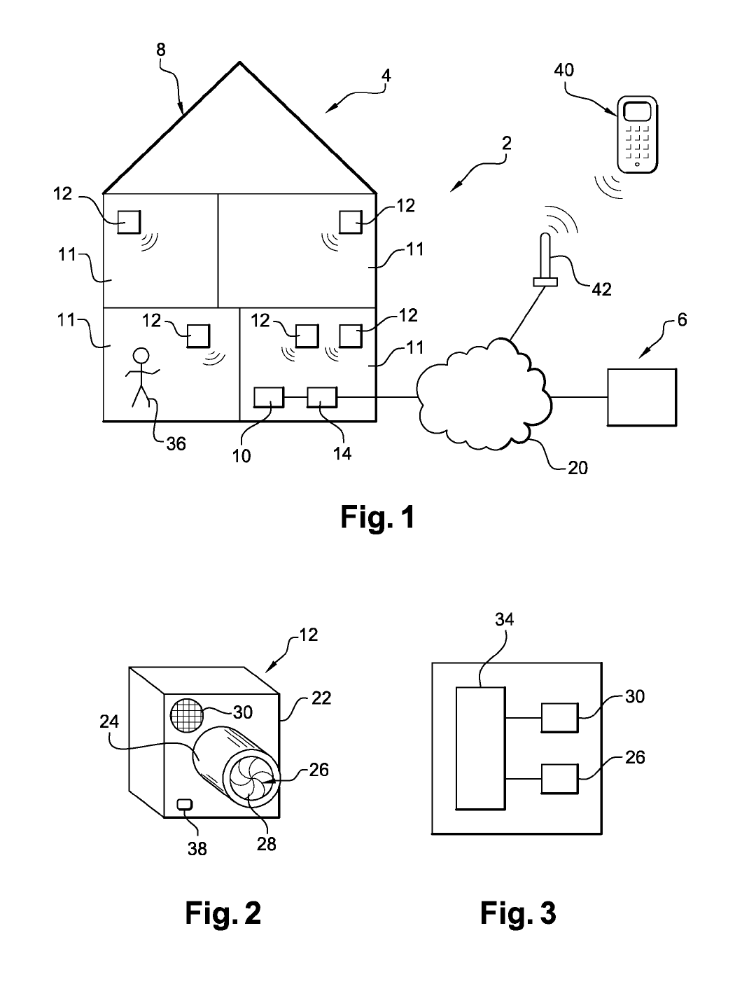

In the present example, as shown in FIG. 1, the remote monitoring system 2 of the invention comprises a monitoring device 4 and a remote monitoring center 6.

The device 4 is situated in an installation or a site under monitoring. Specifically it constitutes a dwelling 8, but it could be premises for professional use. More generally, the installation is a predetermined space for monitoring. The device could equally well be situated close to the installation without being located inside it. Specifically, in this illustration, the installation 8 has four rooms 11, which number could naturally be different.

The device 4 comprises a unit 10 containing conventional computer means such as a central processor unit (CPU), a screen, a keyboard, and a memory, possibly in the form of a hard disk or of a flash memory. This unit 10 forms an alarm station.

The device 4 also has one or more members for detecting movement and/or for viewing different zones of the installation. In this example, these are cameras 12 and there are five of them in the dwelling 8 in this example. This number could be different, it being possible for the device to have a minimum of one camera. Here the device has one camera 12 per room except in the bottom right-hand room where there are two cameras present.

Provision could be made for the cameras 12 to operate with radiation in the visible range or in the infrared range. Specifically, in each room where there is only one camera the camera operates in the visible range. In the room having two cameras, one of them operates in the visible range and the other operates in the infrared range. More generally, provision can be made for the device to comprise one or more cameras operating in the visible range and/or one or more cameras operating in the infrared range.

Each of the cameras operating in the visible range is suitable for transmitting to the station 10 an image of its field of view. The or each camera operating in the infrared range is suitable for detecting a sudden change of radiation in its field of view, for transmitting data to the station 10 concerning the radiation in its field of view and/or concerning the change, or even for locating where the change in radiation comes from.

Each of the cameras 12 is suitable for transmitting the data that it collects in this way to the station 10. In the present example, this transmission is performed by means of a wireless radio connection, however provision could be made, on the contrary, for transmission to take place in a wired mode.

The station 10 includes means for processing the signals it receives in this way and for establishing a diagnosis therefrom concerning the situation of the installation. It can thus determine whether the situation is normal, or on the contrary whether it is abnormal. For example, if an intruder has penetrated into the installation and the presence of the intruder is detected by at least one of the cameras, the station considers this presence is to be an abnormal situation.

The station 10 then informs the remote monitoring center 6. For this purpose, the device 4 has a residential gateway 14 connected to the station 10 and suitable for causing communications therefrom to transit to a telecommunications network 20, such as the Internet. In this example, communication is set up by means of telephone calls transiting at least in part over the Internet. The station 10 is provided for this purpose with conventional means that are themselves known for setting up and receiving such communications.

The device 4 is automatic and operates without the intervention of an operator or of a resident of the installation. Nevertheless, if a resident so desires, it is possible to intervene on the device, for example, by means of the keyboard, and to obtain information from the screen. Specifically, the resident may decide to deactivate the device, for example, on returning to the installation, or to activate it on leaving the installation.

The remote monitoring center 6 is situated remotely and usually it is situated at a considerable distance from the device 4, for example, at least one 1 kilometer (km) or even several kilometers. Like the device 4, the remote monitoring center 6 is automatic. Nevertheless, in this example, a person such as an operator has the role of monitoring proper operation thereof and of dealing with an abnormal situation, should one arise, for example, by triggering an alert. The remote monitoring center 6 also comprises computer processor means and in particular one or more computers. In general, a single remote monitoring center 6 is associated via the network 20 with a plurality of devices of the same type as the device 4, for example, several dozen or several hundred devices. The remote monitoring center 6 is suitable for sending and receiving telephone calls that transit via the network 20. By way of example, on request of the operator, the remote monitoring center 6 is suitable for receiving data from the device 4, for example, images from the cameras 12.

There follows a description in greater detail of the cameras 12 with reference to FIGS. 2 and 3.

Each camera comprises a body 22 and a lens unit 24 fastened to the body and including at least one lens.

The camera includes shut-off means 26 having a mask 28 and a shut-off means mechanism (not shown) suitable for changing the position or the configuration of the mask 28 in order to pass from the open position to the closed position, and vice versa. When the shut-off means are open, the mask uncovers the lens and enables the camera to pick up images in its field of view. When it is closed, the mask covers the lens 24 and prevents the camera from picking up such images.

Each camera 12 also has means for making a predetermined sound. Specifically, these means comprise a buzzer 30. They could alternatively comprise a loudspeaker. Finally, the camera includes computer and automatic control means 34 suitable for controlling the shut-off means 26 and the buzzer 30.

Each of the cameras 12 may alternate between a state referred to as an “inactive” state in which it is not capable of picking up images, and an active state in which, on the contrary, it is capable of picking up images. It is entirely possible, in this state, for it actually to be picking up images and thus to be filming what is taking place in its field of view. In the active state, it is possible, for the camera to be ready to film but without necessarily actually filming: for example, before filming it may be waiting for an order from the station 10 or from the remote monitoring center 6. On the contrary, provision may be made for the camera to film throughout the period in which it is in the active state. Thus, depending on the settings that it is desired to give to the device 4, it is possible to provide for the active state of each camera to correspond to a situation in which the camera is ready to pick up images but is not necessarily doing so all the time, or indeed is not picking up any images at all. Conversely, provision may also be made for the active state to be a state in which the camera is picking up images continuously.

In the present monitoring method, once any one of the cameras 12 has gone from the inactive state to the active state, the control means 34 of the camera operate both the buzzer 30 and the shut-off means 26.

The sound signal from the buzzer is at a level that lies in the range 10 decibels (dB) to 30 dB, and is preferably 20 dB, for example. It can be heard by the occupant(s) 36 of the installation when in the immediate environment of the camera in question. The term “immediate environment” of the camera is used to mean a zone centered on the camera and having a maximum radius from the camera lying in the range 1 meter (m) to 20 m, for example. The occupants are thus warned of the change of state by the sound signal.

Similarly, opening the shut-off means 26 causes the mask 28 to be moved. If the occupant 36 is looking at the camera 12 at that instant, the occupant will see that the mask has changed position. Thereafter, while the camera 12 is in the active state, the occupant may at any time observe that the camera 12 continues to be in the active state merely by looking at the position of the mask.

Conversely, when the camera goes from the active state to the inactive state, the control means operate the buzzer 30 and the shut-off means 26 in like manner so as to make a sound signal and also so as to mask the lens. This sound signal is preferably different from the sound signal made when switching to the active state.

In the present example, each of the cameras 12 is arranged in such a manner as to be suitable for emitting sound signals that differ from the sound signals emitted by the other cameras of the device. By recognizing these sound signals, which are always the same for each of the cameras, each occupant in the installation 8 can thus detect which camera is changing state.

Specifically, each of the cameras 12 is also provided with a light-emitting device 38 on its front face, for example, comprising a light-emitting diode (LED). This diode is switched on whenever the camera is in the active state and off whenever the camera is in the inactive state.

In a variant, it is possible to envisage that each camera 12 emits a sound signal throughout the time that it remains in the active state (which signal may be periodic, for example, in the form of “beep-beep”), for example, at low level compared with the signal that it emits when changing state. Continuous emission of this sound signal then enables occupants situated in the immediate vicinity of the camera to be aware that it is active.

Provision may be made for the device 4 to be arranged to enable the activity taking place in the field of view of one of the cameras 12 to be viewed remotely on a video appliance 40. By way of example, this appliance 40 is a mobile telephone, a personal digital assistant (PDA), or a laptop computer. This facility is preferably made available only to a person having full rights over the monitored installation. For example, it may be a manager or an employee of the firm occupying the premises in the monitored installation, or if the premises is a dwelling, one of the members of the family. This monitoring takes place by setting up communication with the appliance 40 via an antenna 42 connected to the network 20 (directly or indirectly via some other telecommunications network), which antenna is itself put into communication with the station 10. By way of example, a father of a family who is away from home may momentarily observe the other members of the family at home to make sure that the situation is in order. The occupants at home are warned by the means described above whenever each camera 12 goes into the active state, that they are being filmed or that they might be being filmed.

The method of the invention may be implemented by instructions from computer programs stored on a data recording medium, for example, of the flash memory, compact disk (CD), or digital video disk (DVD) type. Provision may be made to make such a program available for downloading over a telecommunications network such as the Internet or a wireless network. Program updates may also be sent over such a network to the station 10 and to the cameras 122.

The invention is applicable to methods and devices for monitoring people who are dependent and/or of who require assistance such as elderly or handicapped people.

Naturally, numerous modifications can be made to the invention without going beyond the ambit thereof.

Provision may be made for the control means to be suitable for issuing the cue solely by moving a mask capable of covering the camera lens, and not in the form of a sound signal. Conversely, provision could be made for the control means to be suitable for making the cue solely in the form of a sound signal, and thus without moving a mask.

In a variant, provision could be made for the emission of the sound signal and the masking of the camera to be performed under the control of the station 10 and not of control means in the camera itself.

While the forms of apparatus herein described constitutes preferred embodiments of this invention, it is to be understood that the invention is not limited to these precise forms of apparatus, and that changes may be made therein without departing from the scope of the invention which is defined in the appended claims.

What is claimed is:

1. A device for monitoring an installation, wherein the device comprises control means suitable for issuing a cue to an environment of a camera indicating that the camera is passing from a state in which it is not capable of picking up images to a state in which it is capable of picking up images, or is indeed picking them up, and vice versa, such that the cue is issued in at least one of the following two forms:
a movement of a mask suitable for covering a lens of the camera; and
a sound signal.

2. The device according to claim 1, wherein said control means is suitable for issuing the cue both in the form of the movement of the shut-off means and in the form of the sound signal.

3. The device according to claim 1, wherein said control means is suitable for issuing the cue in the form of sound signals that differ depending on whether the camera is passing from the state in which it is not in a position to pick up images to the state in which it is in a position to pick up images, or vice versa.

4. The device according to claim 1, wherein the camera includes said control means.

5. The device according to claim 1, wherein said camera includes means for issuing the sound signal.

6. The device according to claim 1, the device having a plurality of cameras, wherein said control means is suitable for issuing the cue by means of sound signals that are different for the respective cameras.

7. A method for monitoring an installation, wherein said method comprises the step of:
issuing a cue to an environment of a camera indicating that the camera is passing from a state in which it is not capable of picking up images to a state in which it is capable of picking up images, or is indeed picking them up, and vice versa, such that the cue is issued in at least one of the following two forms:
a movement of a mask suitable for covering a lens of the camera; and
a sound signal.

8. A computer program, comprising instructions for implementing a method according to claim 7.

9. A data recording medium, including a recording of a program according to claim 8.

10. Making a program according to claim 8 available for downloading on a telecommunications network.

11. A monitoring system for use in an installation, wherein said monitoring system comprises:
a movement detection device for issuing a cue to an environment associated with a camera;
said cue providing at least one of an audio or visual indication that the camera is passing from a state in which it is not capable of picking up images to a state in which it is capable of picking up images, or is indeed picking them up, and vice versa;
said at least one audio or visual indication comprising at least one of the following two forms:
a movement of a mask suitable for covering a lens of the camera; or
a sound signal.

12. The monitoring system according to claim 11, wherein said at least one audio or visual indication comprises both said movement of the shut-off means and said sound signal.

13. The monitoring system according to claim 11, wherein said movement detection device is suitable for issuing the cue in the form of sound signals that differ depending on whether the camera is passing from the state in which it is not in a position to pick up images to the state in which it is in a position to pick up images, or vice versa.

14. The monitoring system according to claim. 11, wherein said camera comprises said movement detection device, said camera being mounted in a room of a structure.

15. The monitoring system according to claim 11, wherein the camera includes means for issuing the sound signal.

16. The monitoring system according to claim 11, wherein said movement detection device comprises a plurality of cameras, wherein said movement detection device is suitable for issuing the cue by generating sound signals that are different for each of the respective cameras.

17. The monitoring system according to claim 11, wherein said monitoring system further comprises a computer program for generating the at least one audio or visual indication.

18. The monitoring system according to claim 17, wherein said monitoring system further comprises a data recording medium, including a recording of said computer program.

19. The monitoring system according to claim 17, wherein said monitoring system is coupled to a communications network, said computer program and said at least one audio or visual indication being available for download over said communications network.
